(19) United States
(12) Patent Application Publication
(10) Pub. No.: US 2016/0255916 A1
(43) Pub. Date: Sep. 8, 2016

(54) Wearable Belt with Belt Buckle Tool Case

(71) Applicant: Richard Ozdowy, Bloomfield Hills, MI (US)

(72) Inventor: Richard Ozdowy, Bloomfield Hills, MI (US)

(21) Appl. No.: 15/059,302

(22) Filed: Mar. 3, 2016

Related U.S. Application Data
(60) Provisional application No. 62/127,764, filed on Mar. 3, 2015.

(51) Int. Cl. A44B 11/00; A45F 5/02; B25H 3/02

(52) U.S. Cl. CPC A44B 11/005; B25H 3/02; A45F 5/021; A45F 2005/023

(57) ABSTRACT

A wearable belt comprising a belt buckle tool case and a belt strap is disclosed. The belt buckle tool case includes at least one tool selected from a folding knife, bottle opener, and screwdriver bit. To access the at least one tool, a removable belt buckle cap can be removed from magnetic attachment with a belt buckle base. The at least one tool is magnetically coupled to the removable belt buckle cap. The belt buckle base remains coupled to the belt strap when the removable belt buckle cap is removed. A belt buckle tool case is also disclosed, wherein a removable belt buckle cap is coupled to a belt buckle base. At least one tool is coupled to the removable belt buckle cap.

### CROSS REFERENCE TO RELATED APPLICATIONS

This application claims priority to U.S. Provisional Patent Application No. 62/127,764, filed Mar. 3, 2015, entitled “Belt Buckle Tool Case,” which is incorporated herein by reference in its entirety.

### TECHNICAL FIELD OF THE INVENTION

The present invention relates to the field of consumer hand tools. More specifically, the invention combines highly used hand tools with a standard pants belt.

### BACKGROUND OF THE INVENTION

Multi tools are becoming increasingly popular, especially in the wearable category. Multiple belt-buckle multi tools already exist in the current market space. The belt-buckle multi tools primarily function by removing the belt buckle in order to use the multi tool functionality. Often the buckles are shaped to embed the functionality within the buckle itself. These buckles usually contain some combination of the following tools: bottle opener, knife, screwdriver, and wrench.

### SUMMARY OF THE INVENTION

The present invention serves to provide wearers with quick and easy access to a folding knife, a bottle opener, and a variety of screwdriver bits. The present invention also is intended to be worn as a belt buckle with all above tools enclosed therein. The present invention, when worn, shall not look considerably different than a normal belt buckle in casual or business settings.

### BRIEF DESCRIPTION OF THE DRAWINGS

Reference numerals in the drawings:

8 Belt buckle tool case;

10 Belt buckle base;

12 Bottle opener;

14 Folding knife;

16 Screwdriver bits;

18 Hexagonal screwdriver slot;

20 Lip;

22 Removable belt buckle cap;

26 Rectangular protrusion;

28 Inner perimeter;

30 Belt pin;

32 Belt strap holder;

34 Aperture;

36 Belt strap;

38 Tool magnet;

40 Belt buckle magnet;

42 Belt buckle base cavity;

44 Removable belt buckle cap cavity;

46 Bottom surface;

48 Mating holes.

FIG. 1 is a fully assembled top view of one embodiment of the present invention.

FIG. 2 is a view of a removable belt buckle cap with tools.

FIG. 3 is a view of the removable belt buckle cap from FIG. 2 with some tools removed.

FIG. 4 is a view of a belt buckle base.

FIG. 5 is a view of the removable belt buckle cap and the belt buckle base.

FIG. 6 a top view of the removable belt buckle cap with a screwdriver bit installed in a hexagonal screwdriver slot.

FIG. 7 is a view of the belt buckle base of FIG. 4 with magnets.

FIG. 8 is a view of the removable belt buckle cap with magnets.

FIG. 9 is a side view showing a hexagonal screwdriver slot in the removable belt buckle cap.

FIG. 10 is a view of a fully assembled wearable belt with belt buckle tool case.

FIG. 11 is a bottom view of a belt buckle base.

FIG. 12 is a view of a belt strap coupled to a belt strap holder.

FIG. 13 is a bottom view of the wearable belt of FIG. 10.

### DETAILED DESCRIPTION OF THE INVENTION

The present invention is a belt buckle which can be opened, revealing a removable set of tools contained within a removable belt buckle cap 22 and a belt buckle base 10. The tools provided will be a combination of a folding knife 14, a bottle opener 12, and a variety of screwdriver bits 16. The bottle opener 12 is located on the removable belt buckle cap 22. Other tools, such as a wrench, can also be contained within the removable belt buckle cap 22. One skilled in the art would readily understand that many useful tools could be contained within the removable belt buckle cap 22.

The tools and belt buckle tool case 8 may preferably be made from metal, such as stainless steel or aluminum. Plastic, carbon fiber, or other materials may also be used without departing from the scope of the invention. The removable belt buckle cap 22 and belt buckle base 10 may be made by stamping, machining, molding, or any other standard metal or plastic working process known in the art. Preferably, they may be made of metal by die casting.

The folding knife 14 is a foldable knife with a small enough profile to fit within the small dimensional constraints of the belt buckle. The screwdriver bits 16 are 4 mm thick hexagonal bits. The folding knife 14 and the screwdriver bits 16 are secured magnetically or in a similar fashion to the removable belt buckle cap 22, and are well known in the art. The bottle opener 12 may be die cast as part of the removable belt buckle cap 22. The bottle opener 12 may alternatively be formed separately from the removable belt buckle cap 22 and secured in any other fashion as desired, such as a magnetic or welded attachment, for example, to said removable belt buckle cap 22.

The removable belt buckle cap 22 is shaped such that its edges lay flush with the sides of the belt buckle base 10. A rectangular protrusion 26 of the removable belt buckle cap 22 is designed as a slightly undersized fit to the inner perimeter 28 of the belt buckle base 10, ensuring a flush fit when the removable belt buckle cap 22 and belt buckle base 10 are coupled together to form the belt buckle tool case 8. The rectangular protrusion 26 therefore resides within belt buckle base cavity 42 of the belt buckle base 10 formed by the inner perimeter 28 and the belt buckle base 10. The height H of the belt buckle tool case 8 will not exceed about 12 mm, more preferably about 8 mm, such as to allow the buckle assembly to sit comfortably on the wearer such that it is not construed as excessively large. One skilled in the art would readily understand that any size belt buckle tool case 8 could be used without departing from the scope of the invention.

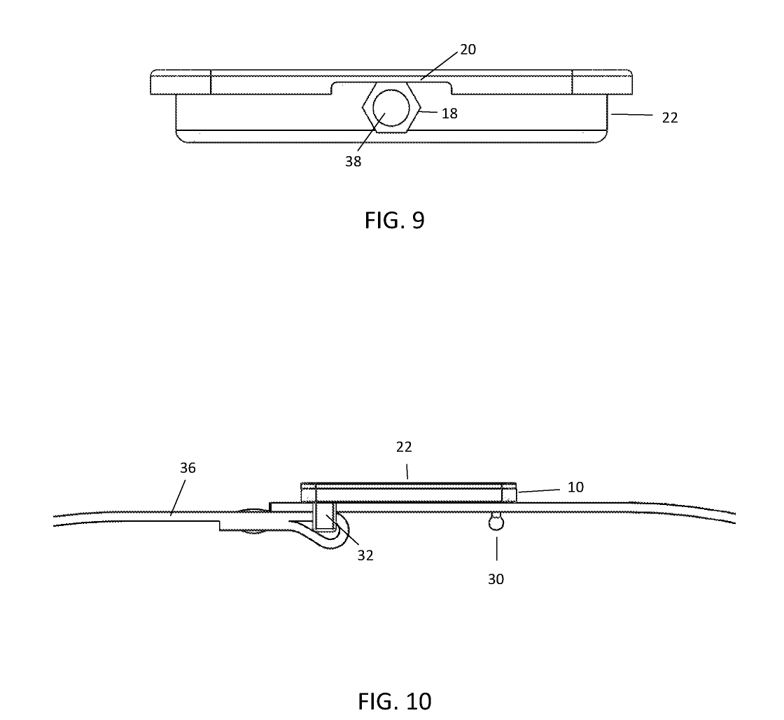

Included in the removable belt buckle cap 22 is a hexagonal screwdriver slot 18. The screwdriver bits 16 can be removed from the inside of the removable belt buckle cap 22 and inserted into the hexagonal screwdriver slot 18, thus creating a screwdriver with the removable belt buckle cap 22 as the handle. Though the screwdriver bits 16 are 4 mm thick hexagonal bits, they could be any other type or size of screwdriver bit as desired. The hexagonal screwdriver slot 18 could therefore be readily made to fit the chosen screwdriver bit style. As shown in FIG. 9, a tool magnet 38 may be placed inside the hexagonal screwdriver slot 18 to ensure the screwdriver bit 16 remains in a secure position. The tool magnet 38 may be secured in the hexagonal screwdriver slot 18 by adhesive, for example, or any other suitable method known in the art.

As shown in FIG. 2 and FIG. 8, tool magnets 38 are coupled to an inner surface of the removable belt buckle cap 22 by adhesive, for example, or any other suitable method known in the art, such as a welded attachment. Folding knife 14 and screwdriver bits 16 may be coupled to said tool magnets 38, thus coupling the folding knife 14 and screwdriver bits 16 to the removable belt buckle cap 22. When the removable belt buckle cap 22 is removed from attachment with the belt buckle base 10, the folding knife 14 and screwdriver bits 16 will remain coupled to the tool magnets 38, and therefore will remain coupled to the removable belt buckle cap 22. Any number of tool magnets 38 may be used in multiple locations, as desired, to ensure a strong coupled arrangement between the tools and the removable belt buckle cap 22. Multiple tool magnets 38 may also be coupled to each other by adhesive, or other suitable method, for spacial arrangement reasons, for example. As shown in FIG. 2, the tools and tool magnets 38 are contained within a removable belt buckle cap cavity 44 formed by the rectangular protrusion 26 and the removable belt buckle cap 22.

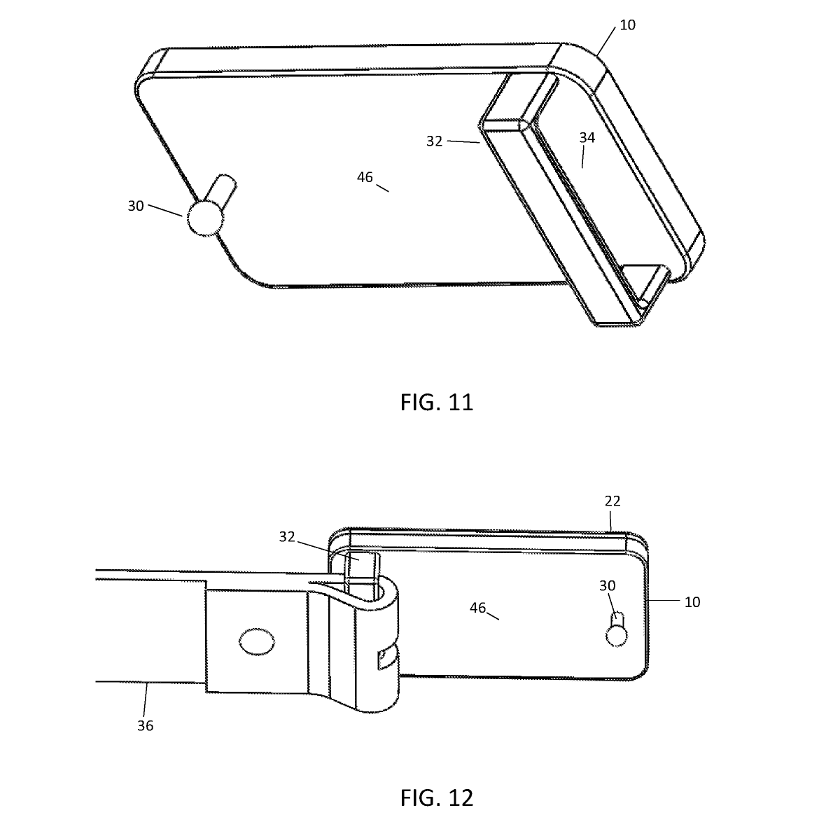

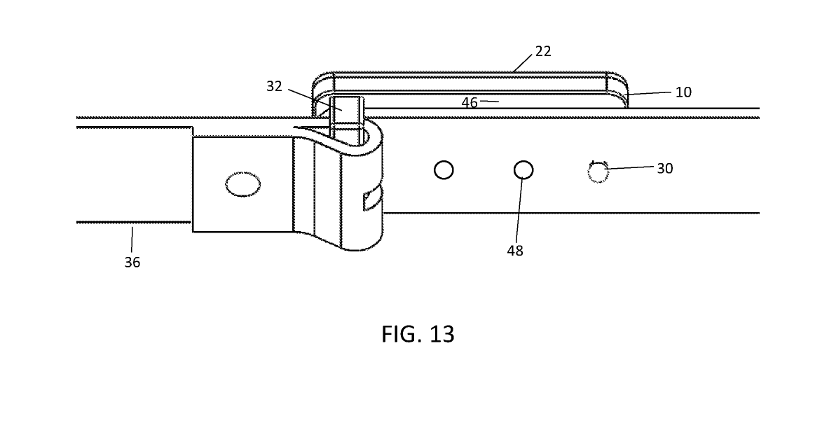

The external mating features of the buckle, as shown in FIG. 11-13, are defined as the belt strap holder 32 and the belt pin 30. The belt pin 30 is formed as part of the belt buckle base 10 and is a protrusion on the belt buckle base 10 bottom surface 46. This component serves to secure the belt buckle base 10 to mating holes 48 on a belt strap 36 in a releasable connection. The belt strap holder 32 is formed as part of the belt buckle base 10 and is a loop protrusion on the belt buckle base 10 bottom surface 46. This component serves to secure the belt buckle base 10 to the belt strap 36 by looping the belt strap 36 through an aperture 34 in the belt strap holder 32 and subsequently attaching the belt strap 36 to itself, thus enclosing itself around the belt strap holder 32. The belt strap 36 may be any standard pants belt, made from leather, plastic, rubber, fabric, or any other suitable material and may attach to itself via any suitable method known in the art, such as with stitching, adhesive, or a fastener such as a rivet. The belt pin 30 and belt strap holder 32 may preferably be die cast as part of the belt buckle base 10. The belt pin 30 and belt strap holder 32 may alternatively be formed separately from the belt buckle base 10 and secured in any other fashion as desired, such as a magnetic or welded attachment, for example, to said belt buckle base 10.

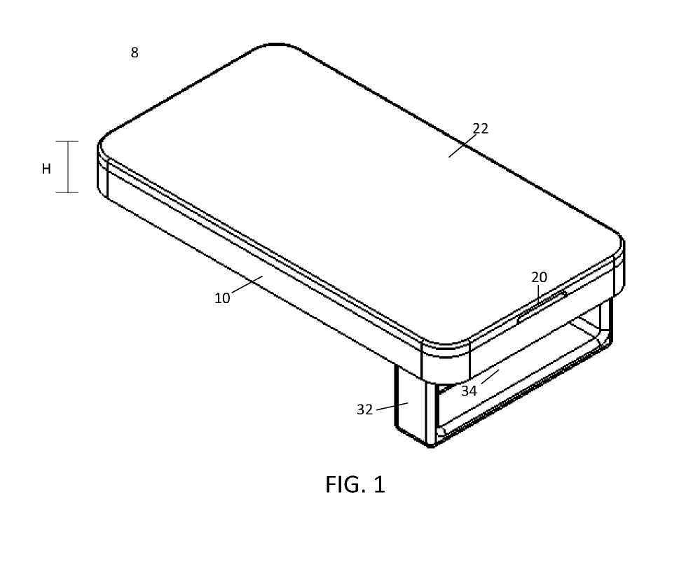

As seen in FIG. 1, the belt buckle tool case 8 is shown, comprising a removable belt buckle cap 22 and a belt buckle base 10. Lip 20 allows the belt wearer to easily pop off the removable belt buckle cap 22 in order to access and use the tools within by placing a finger, for example, under the lip 20 and pulling away from the belt buckle base 10. FIG. 2 shows the removable belt buckle cap 22 with folding knife 14, bottle opener 12, and screwdriver bits 16 coupled to the inside surface via at least one tool magnet 38. The at least one tool magnet 38 is also shown in FIG. 8, coupled to an internal surface of the removable belt buckle cap 22 via adhesive. The at least one magnet 38 may be held in place by any suitable mechanism other than adhesive, such as welding, for example.

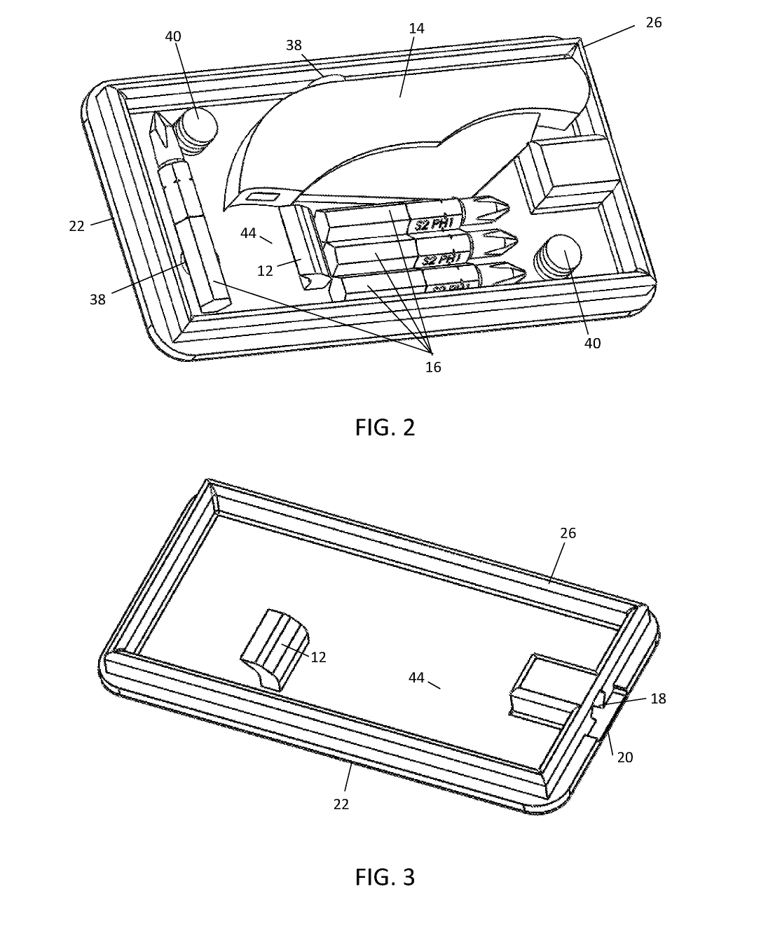

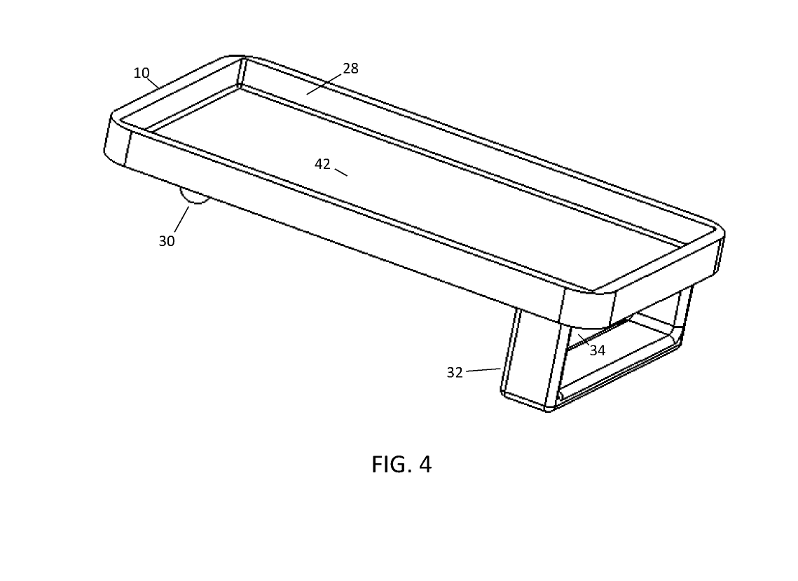

FIG. 3-4 show the removable belt buckle cap 22 and the belt buckle base 10, respectively, decoupled. The hexagonal screwdriver slot 18 is shown, providing a port for inserting a screwdriver bit 16 and using the assembly as a screwdriver, as previously described and as shown in FIG. 6. FIG. 6 shows a screwdriver bit 16 inserted into the hexagonal screwdriver slot 18.

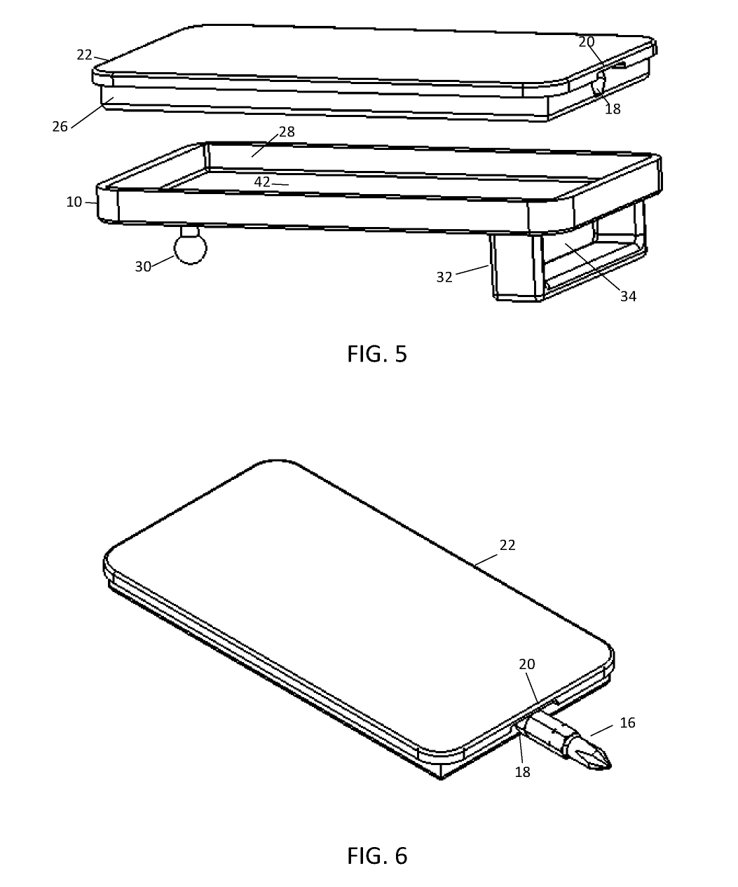

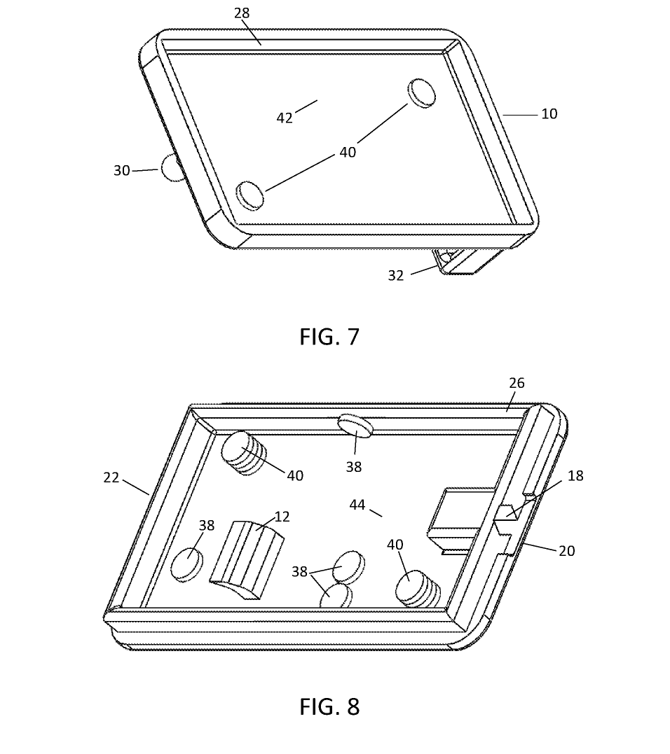

The rectangular protrusion 26 aligns with the inner perimeter 28 of the belt buckle base 10 and makes a flush fit when brought together, as can be seen in FIG. 1 and FIG. 5. As shown in FIG. 2 and FIG. 7-8, belt buckle magnets 40 hold the removable belt buckle cap 22 and belt buckle base 10 together to form the belt buckle tool case 8. The belt buckle magnets 40 couple the removable belt buckle cap 22 to the belt buckle base 10. In order to couple together, at least one belt buckle magnet 40 is coupled to the removable belt buckle cap 22 and at least one belt buckle magnet 40 is coupled to the belt buckle base 10 in a corresponding location. A corresponding location means the belt buckle magnets 40 are located so as to couple to each other when the belt buckle tool case 8 is assembled. As shown in FIG. 5, the removable belt buckle cap 22 and belt buckle base 10 are in alignment for coupling together and, in this state, corresponding belt buckle magnets 40 on both the removable belt buckle cap 22 and the belt buckle base 10 will be aligned and may magnetically couple to each other when brought together, holding the belt buckle tool case 8 in an assembled state. As shown in FIG. 8, multiple belt buckle magnets 40 may be coupled to each other via adhesive, or other suitable method, to ensure contact between the corresponding belt buckle magnets 40 on the removable belt buckle cap 22 and belt buckle base 10 when brought together. This ensures a flush fit when the belt buckle tool case 8 is fully assembled. Alternatively, larger magnets could be used, for example, to perform the required coupling feature as described.

FIG. 10 and FIG. 12 show a wearable belt with belt buckle tool case completely assembled. At least one tool is coupled to the removable belt buckle cap 22. When the removable belt buckle cap 22 is removed from attachment with the belt buckle base 10, the belt buckle base 10 will remain coupled to the belt strap. The at least one tool will remain coupled to the removable belt buckle cap 22 until removed for use by a user, such as the belt wearer for example.

The above description is to be understood as describing only some embodiments of the present invention and is not intended to be exhaustive. One of ordinary skill in the art will understand that variations of the disclosed embodiments are possible without departing from the scope of the included claims.

What is claimed is:

1. A wearable belt comprising
a belt strap;
a belt buckle tool case comprising a removable belt buckle cap coupled to a belt buckle base;
at least one tool coupled to the removable belt buckle cap;
wherein the belt buckle base is coupled to the belt strap and remains coupled to the belt strap when the removable belt buckle cap is removed.

2. A wearable belt according to claim 1, wherein the at least one tool comprises a folding knife.

3. A wearable belt according to claim 1, wherein the at least one tool comprises a bottle opener.

4. A wearable belt according to claim 1, wherein the at least one tool comprises at least one screwdriver bit.

5. A wearable belt according to claim 4, wherein the at least one screwdriver bit is a 4 mm thick hexagonal bit.

6. A wearable belt according to claim 4, wherein the removable belt buckle cap further comprises a hexagonal screwdriver slot.

7. A wearable belt according to claim 1, wherein the removable belt buckle cap is magnetically coupled to the belt buckle base before being removed.

8. A wearable belt according to claim 1, wherein the at least one tool is magnetically coupled to the removable belt buckle cap.

9. A wearable belt according to claim 1, wherein the belt buckle tool case does not exceed about 8 mm in total height when the removable belt buckle cap is coupled to the belt buckle base.

10. A wearable belt according to claim 1, wherein the belt buckle base further comprises a cavity and an inner perimeter and the removable belt buckle cap comprises a protrusion.

11. A wearable belt according to claim 10, wherein the protrusion is sized to fit flush with the inner perimeter of the belt buckle base and reside inside the cavity.

12. A wearable belt comprising
a belt strap;
a belt buckle tool case comprising a removable belt buckle cap coupled to a belt buckle base;
at least one tool coupled to the removable belt buckle cap;
wherein the belt buckle base comprises a bottom surface and at least one belt strap holder extending from the bottom surface.

13. A wearable belt according to claim 12, wherein the belt strap holder comprises an aperture and wherein the belt strap is configured to extend through the aperture and connect to itself, thereby making a secure connection between the belt strap and the belt buckle base.

14. A wearable belt according to claim 12, wherein the belt buckle base further comprises at least one belt pin protruding from the bottom surface.

15. A wearable belt according to claim 14, wherein the belt strap includes at least one mating hole capable of being coupled to the at least one belt pin, thereby making a releasable connection between the belt strap and the belt buckle base.

16. A belt buckle tool case comprising
a removable belt buckle cap coupled to a belt buckle base;
at least one tool coupled to the removable belt buckle cap.

17. A belt buckle tool case according to claim 16, further comprising a belt strap coupled to the belt buckle base.

18. A belt buckle tool case according to claim 16, wherein the at least one tool is a folding knife.

19. A belt buckle tool case according to claim 16, wherein the at least one tool is a bottle opener.

20. A belt buckle tool case according to claim 16, wherein the at least one tool is at least one screwdriver bit.
